(19) United States
(12) Patent Application Publication
(10) Pub. No.: US 2026/0316731 A1
(43) Pub. Date: Oct. 15, 2026

(54) WHEEL- SPECIFIC OR AXLE-SPECIFIC BRAKE MODULE

(71) Applicant: Robert Bosch GmbH, Stuttgart (DE)

(72) Inventors: Ralf Kleemann, Benningen Am Neckar (DE); Bernd Hienz, Baindt (DE); Tobias Loss, Ludwigsburg (DE)

(21) Appl. No.: 19/547,850

(22) Filed: Feb. 24, 2026

(30) Foreign Application Priority Data
Mar. 12, 2025 (DE) 10 2025 109 449.7

(51) Int. Cl. B60T 13/14

(52) U.S. Cl. CPC B60T 13/148; B60T 2270/402; B60T 2270/413; F16D 2250/0084

(57) ABSTRACT

A wheel-specific or axle-specific brake module. The brake module includes first and second motorized brake pressure build-up devices, at least one single-piston or multi-piston wheel brake cylinder, wherein a total number of wheel brake cylinders of the brake module is less than or equal to 2, and at least one wheel inlet valve and/or wheel outlet valve. The first motorized brake pressure build-up device is connected to a brake fluid reservoir of the brake module via a first suction line and the second motorized brake pressure build-up device is connected to the brake fluid reservoir via a second suction line, the first motorized brake pressure build-up device is connected to a common line section via a first supply line having a separating valve and the second motorized brake pressure build-up device is connected to the common line section via a second supply line.

### FIELD

The present disclosure relates to a wheel-specific or axle-specific brake module. The present disclosure also relates to a manufacturing method for a wheel-specific or axle-specific brake module. Furthermore, the present disclosure relates to a method for operating a wheel-specific or axle-specific brake module.

### BACKGROUND INFORMATION

Germany Patent Application No. DE 10 2020 216 322 A1 describes an axle unit for a brake system of a vehicle having at least two axles, wherein a total number of all wheel brake cylinders of the axle unit is equal to two and the axle unit comprises two motorized brake pressure build-up devices. A first wheel brake cylinder of the two wheel brake cylinders is connected to a first motorized brake pressure build-up device of the two motorized brake pressure build-up devices via a first separating valve and to a second motorized brake pressure build-up device of the two motorized brake pressure build-up devices via a second separating valve, while a second wheel brake cylinder of the two wheel brake cylinders is connected to the first motorized brake pressure build-up device via a third separating valve and to the second motorized brake pressure build-up device via a fourth separating valve.

Furthermore, Germany Patent Application Nos. DE 10 2004 009 466 A1, DE 10 2008 039 960 A1, DE 10 2013 222 949 A1 and DE 10 2018 133 189 A1 describes hydraulic brake systems for vehicles.

### SUMMARY

The present disclosure relates to a wheel-specific or axle-specific brake module, a manufacturing method for a wheel-specific or axle-specific brake module and a method for operating a wheel-specific or axle-specific brake module.

The present disclosure provides wheel-specific or axle-specific brake modules that, when present in a fault-free state, enable a wheel-specific hydraulic brake pressure build-up in their single wheel brake cylinder or in their exactly two wheel brake cylinders. In addition, in the wheel-specific or axle-specific brake modules realized by means of the present disclosure, sufficient redundancy is ensured in a plurality of fault cases to effect deceleration of a vehicle equipped therewith. The wheel-specific or axle-specific brake modules provided by means of the present disclosure are thus suitable for realizing a decentralized brake system of the vehicle equipped therewith, in which braking can continue to be performed at all wheels of the vehicle in a plurality of fault cases. As becomes apparent from the following description, the advantageous redundancy of a wheel-specific or axle-specific brake module according to the disclosure, or of the decentralized brake system realized therewith, is associated with no or hardly any increased effort or additional costs in the manufacture of the particular wheel-specific or axle-specific brake module.

The present disclosure thus also contributes significantly to improving decentralized brake systems, so that their advantages can be utilized even more frequently. Thus, the present disclosure is suitable for a brake system type in which its actuators are typically installed directly at a wheel and/or at an axle of the vehicle to be decelerated. The decentralized brake systems realized by means of the present disclosure thus provide advantages regarding controllability, due to a (substantially) complete independence of the various wheel-specific or axle-specific brake modules of the decentralized brake system. Additionally, by omitting conventionally necessary brake lines in a decentralized brake system realized by means of the present disclosure, brake fluid can be saved (generally). Furthermore, packaging advantages can be achieved by a space freed up in the engine compartment. The assembly and replacement of a decentralized brake system are also generally less complex and more cost-effective than corresponding processes in a central brake system.

In an advantageous example embodiment of the wheel-specific or axle-specific brake module, by means of operation of the first motorized brake pressure build-up device, brake fluid can be transferred through the at least partially open separating valve, through the common line section, and through the at least one at least partially open wheel inlet valve into the at least one wheel brake cylinder of the brake module, while, by means of operation of the second motorized brake pressure build-up device, brake fluid can be transferred through the common line section and through the at least one at least partially open wheel inlet valve into the at least one wheel brake cylinder of the brake module, and additionally brake fluid can be discharged from the at least one wheel brake cylinder of the brake module through the at least one at least partially open wheel outlet valve into the brake fluid reservoir. The hydraulic brake module architecture described here not only achieves a high redundancy of the wheel-specific or axle-specific brake module, but also a wheel-specific hydraulic brake pressure build-up and brake pressure reduction in each of its wheel brake cylinders at least when the wheel-specific or axle-specific brake module is present in a fault-free state.

Furthermore, a first end of the second supply line can open into the second motorized brake pressure build-up device and a second end of the second supply line can open into the common line section, and the second supply line can be a valve-free line path. In contrast to the related art explained above, at least one separating valve can thus be omitted in the wheel-specific or axle-specific brake module or replaced by at least one valve for fulfilling an additional function.

Preferably, a line having a check valve runs parallel to the separating valve. Thus, even if the separating valve gets stuck in its closed state, a brake pressure build-up in the at least one wheel brake cylinder of the wheel-specific or axle-specific brake module described here can still be effected by means of operation of the first motorized brake pressure build-up device.

In a further advantageous example embodiment of the wheel-specific or axle-specific brake module, a check valve is arranged in the first suction line and/or a check valve is arranged in the second suction line. This enables both a supply of brake fluid from the brake fluid reservoir to the first motorized brake pressure build-up device and/or to the second motorized brake pressure build-up device, but prevents an undesired outflow of brake fluid via the first suction line and/or the second suction line into the brake fluid reservoir.

For example, the check valve in the first suction line can be a spring-loaded check valve. Such a spring-loaded check valve is particularly suitable for replenishment of a motorized piston-cylinder device used as the first motorized brake pressure build-up device, having at least one linearly movable piston.

Preferably, the first motorized brake pressure build-up device is a motorized piston-cylinder device having at least one linearly movable piston and the second motorized brake pressure build-up device is at least one pump. Thus, the different dynamics of the embodiments described here for the first motorized brake pressure build-up device and the second motorized brake pressure build-up device can be advantageously utilized for the functions to be performed by the particular wheel-specific or axle-specific brake module.

In particular, the separating valve can be a normally open valve. Thus, even in the event of an on-board electrical system failure, “free breathing” can still take place via the separating valve, which is present in a normally open state.

As an advantageous development, the brake module can comprise at least one control unit, by means of which the first motorized brake pressure build-up device and the second motorized brake pressure build-up device are controllable in such a way that brake fluid can be transferred into the at least one wheel brake cylinder of the brake module by means of operation of the first motorized brake pressure build-up device and simultaneously by means of operation of the second motorized brake pressure build-up device. This can be used in particular for a relatively rapid brake pressure build-up in the at least one wheel brake cylinder of the brake module, e.g., for emergency braking or for strong deceleration of the fast-moving vehicle. Thus, the embodiment of the wheel-specific or axle-specific brake module described here contributes to achieving good driving comfort and a high safety standard of the vehicle equipped therewith.

Moreover, the performance of a corresponding manufacturing method for a wheel-specific or axle-specific brake module ensures the advantages described above. The manufacturing method can also be further developed according to the embodiments of the wheel-specific or axle-specific brake module explained above.

Furthermore, the performance of a corresponding method for operating a wheel-specific or axle-specific brake module also provides the advantages explained above. The method for operating a wheel-specific or axle-specific brake module can likewise be further developed according to the embodiments of the wheel-specific or axle-specific brake module explained above.

### BRIEF DESCRIPTION OF THE DRAWINGS

Further features and advantages of the present disclosure will be explained in the following with reference to the figures.

FIG. 1 is a schematic representation of an example embodiment of the wheel-specific or axle-specific brake module.

FIG. 2 is a flow diagram for explaining an example embodiment of the manufacturing method for a wheel-specific or axle-specific brake module.

FIG. 3 is a flow diagram for explaining an example embodiment of the method for operating a wheel-specific or axle-specific brake module.

### DETAILED DESCRIPTION OF EXAMPLE EMBODIMENTS

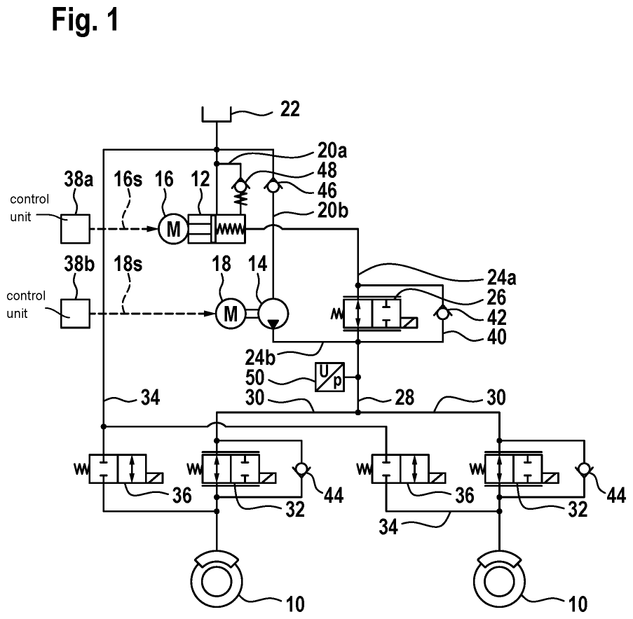

FIG. 1 is a schematic representation of an embodiment of the wheel-specific or axle-specific brake module.

The wheel-specific or axle-specific brake module schematically shown in FIG. 1 is usable at and/or in a vehicle/motor vehicle. It is expressly pointed out that usability of the wheel-specific or axle-specific brake module described below is not limited to any specific vehicle type/motor vehicle type of the vehicle/motor vehicle.

A wheel-specific or axle-specific brake module is to be understood as a module that is formed with at least one wheel brake cylinder 10, wherein a total number of wheel brake cylinders 10 of the brake module is less than or equal to two. Thus, the wheel-specific or axle-specific brake module has either only a single wheel brake cylinder 10 or exactly two wheel brake cylinders 10, wherein the particular wheel brake cylinder 10 can optionally be understood as a single-piston wheel brake cylinder 10 or a multi-piston wheel brake cylinder 10. In particular, the particular wheel brake cylinder 10 can comprise, in addition to at least one hydraulically movable piston, at least one piston that is movable purely electromotively by means of an electric motor (not shown). However, it is expressly pointed out that a brake system having three or more wheel brake cylinders 10 is not to be understood as a wheel-specific or axle-specific brake module. The wheel-specific or axle-specific brake module can thus be, for example, an electromechanical brake (EMB) assignable to a single wheel of the vehicle/motor vehicle or an axle brake module assignable to an axle of the vehicle/motor vehicle, in particular a front axle or a rear axle.

The wheel-specific or axle-specific brake module comprises a first motorized brake pressure build-up device 12 and a second motorized brake pressure build-up device 14. The first and second motorized brake pressure build-up devices 12 and 14 are in each case to be understood as actuators/brake actuators, wherein a first electric motor 16 of the first motorized brake pressure build-up device 12 can be activated, operated and deactivated independently of a second electric motor 18 of the second motorized brake pressure build-up device 14. The first motorized brake pressure build-up device 12 is connected to a brake fluid reservoir 22 of the brake module via a first suction line 20a. Furthermore, the second motorized brake pressure build-up device 14 is likewise connected to the brake fluid reservoir 22 via a second suction line 20b. A connection of a component to the brake fluid reservoir 22 can be understood as a connection to a single chamber or to one of the chambers of the brake fluid reservoir 22, in particular to one of a total of three chambers of the brake fluid reservoir 22.

The first motorized brake pressure build-up device 12 is additionally connected to a common line section 28 via a first supply line 24a having a separating valve 26 arranged therein. The second motorized brake pressure build-up device 14 is also connected to the common line section 28 via a second supply line 24b. The second supply line 24b can be understood as a line path whose first end opens into the second motorized brake pressure build-up device 14 and whose second end opens into the common line section 28. Preferably, the second supply line 24b is a valve-free line path.

As can be seen in FIG. 1, the at least one wheel brake cylinder 10 of the brake module is connected to the common line section 28 via at least one further supply line 30 having at least one wheel inlet valve 32 arranged therein. In this way, it is ensured that, by means of operation of the first motorized brake pressure build-up device 12, brake fluid can be transferred/is transferred through the at least partially open separating valve 26, (after passing through the separating valve 26) through the common line section 28, and (after passing through the common line section 28) through the at least one at least partially open wheel inlet valve 32 into the at least one wheel brake cylinder 10 of the brake module. Optionally, alternatively or additionally, by means of operation of the second motorized brake pressure build-up device 14, brake fluid can be transferred/is transferred through the common line section 28 and (after passing through the common line section 28) through the at least one at least partially open wheel inlet valve 32 into the at least one wheel brake cylinder 10 of the brake module. Thus, the wheel-specific or axle-specific brake module has a hydraulic brake module architecture in which two actuators, which are usable independently of one another to increase a brake pressure in the at least one wheel brake cylinder 10, are combined/integrated in a single module. Even a failure of one of the motorized brake pressure build-up devices 12 or 14 can thus be bridged at least temporarily by means of operation or continued operation of the other motorized brake pressure build-up device 12 or 14. Thus, the wheel-specific or axle-specific brake module described here has a relatively high redundancy.

As it is equipped with the two actuators that are usable independently of one another for increasing brake pressure in the at least one wheel brake cylinder 10 of the brake module, the brake module has a fallback level that, as long as the brake module has two wheel brake cylinders 10, can be used for both wheel brake cylinders 10. Even in the event of failure of one of the two motorized brake pressure build-up devices 12 or 14, a mechanical fallback level can thus be dispensed with. Thus, it is also possible to dispense with a driver mechanically braking into the at least one wheel brake cylinder 10 of the brake module by means of driver brake force in the event of a fault. Thus, the wheel-specific or axle-specific brake module described here is suitable for realizing a so-called true-by-wire brake system, in which a driver braking request is detected by an electronically connected brake actuation element/brake pedal, without the driver brake force being used to increase brake pressure in the wheel brake cylinders 10 of the true-by-wire brake system. In the brake module designed as an axle brake module in FIG. 1, a brake pressure prevailing in the two wheel brake cylinders 10 can, in a backup case, even be set to a desired value for the axle decelerated thereby, as a result of which the vehicle/motor vehicle equipped therewith does not have to be decelerated using a technology designed “to the weakest wheel.”

The at least one wheel brake cylinder 10 of the brake module is, as can be seen in FIG. 1, connected to the brake fluid reservoir 22 via at least one return line 34 having at least one wheel outlet valve 36 arranged therein. Thus, brake fluid can be discharged from the at least one wheel brake cylinder 10 of the brake module through the at least one at least partially open wheel outlet valve 36 into the brake fluid reservoir 22. Equipping the brake module with the one brake fluid reservoir 22 is sufficient.

Advantageously, the brake module can further interact with at least one control unit 38a and 38b. The at least one control unit 38a and 38b can in particular each be part of the brake module. Preferably, the first motorized brake pressure build-up device 12 and the second motorized brake pressure build-up device 14 are controllable/controlled by means of the at least one control unit 38a and 38b in such a way that brake fluid can be transferred/is transferred into the at least one wheel brake cylinder 10 of the brake module by means of operation of the first motorized brake pressure build-up device 12 and simultaneously by means of operation of the second motorized brake pressure build-up device 14. By means of such a design and/or programming of the at least one control unit 38a and 38b, the brake pressure in the at least one wheel brake cylinder 10 of the brake module can thus be increased relatively quickly, which increases driving comfort and a safety standard of the vehicle/motor vehicle equipped with the wheel-specific or axle-specific brake module.

It is particularly advantageous if the brake module interacts with or is equipped with two control units 38a and 38b. If applicable, the first motorized brake pressure build-up device 12, the at least one wheel inlet valve 32 and the at least one wheel outlet valve 36 can be controlled by a first control unit 38a, while the second motorized brake pressure build-up device 14 and the separating valve 26 are controlled by a second control unit 38b. However, for the sake of improved clarity, only the motor control signals 16s and 18s output by the control units 38a and 38b for controlling the first electric motor 16 and the second electric motor 18 are shown in FIG. 1.

As long as the vehicle/motor vehicle equipped with the wheel-specific or axle-specific brake module has two redundant on-board electrical systems (not shown), the first motorized brake pressure build-up device 12, the at least one wheel inlet valve 32 and the at least one wheel outlet valve 36 are preferably electrically connected to a first on-board electrical system of the vehicle/motor vehicle, while the second motorized brake pressure build-up device 14 and of the closing valve 26 is powered by a second on-board electrical system of the vehicle/motor vehicle. Even a failure of one of the on-board electrical systems of the vehicle/motor vehicle can thus be bridged well, so that the vehicle/motor vehicle can, if applicable, still be reliably brought to a standstill.

The separating valve 26 is preferably a normally open valve, so that, even in the event of a failure of its control and/or its power supply, brake fluid can still be transferred into the at least one wheel brake cylinder 10 of the brake module via the open separating valve 26, the common line section 28 and the at least one at least partially open wheel inlet valve 32 by means of operation of the first motorized brake pressure build-up device 12. A line 40 having a check valve 42 arranged therein preferably also runs parallel to the separating valve 26. Thus, even if the separating valve 26 gets stuck in its closed state, brake fluid can still be displaced through the pressed-open check valve 42, through the common line section and through the at least one at least partially open wheel inlet valve 32 into the at least one wheel brake cylinder 10 of the brake module by means of operation of the first motorized brake pressure build-up device 12. A check valve 44 can also be used in parallel with the at least one wheel inlet valve 32.

As shown in FIG. 1, in a preferred embodiment of the brake module, a motorized piston-cylinder device 12 having at least one linearly movable piston is used as the first motorized brake pressure build-up device 12, and at least one pump 14 is used as the second motorized brake pressure build-up device 14. The fact that the at least one pump 14 has a “separate suction path” as a second suction path 20b relative to the first suction path 20a of the motorized piston-cylinder device 12 is advantageous in particular at low temperatures. Preferably, another check valve 46 is inserted into the second suction line 20b.

A check valve 48 can also be inserted into the first suction line 20a. The check valve 48 in the first suction line 20a is preferably a spring-loaded check valve 48, which enables relatively rapid replenishment of the motorized piston-cylinder device 12 (i.e., intake of brake fluid from the brake fluid reservoir into the motorized piston-cylinder device 12) via the at least one wheel outlet valve 36) by means of operation of the at least one pump 14 via the at least partially open separating valve 26. For replenishment, it is sufficient to control/switch the separating valve 26 to be at least partially open and the at least one wheel inlet valve 32 to be closed during operation of the at least one pump 14.

Preferably, for brake pressure build-up in the at least one wheel brake cylinder 10 of the brake module, the motorized piston-cylinder device 12 is used (with the separating valve 26 at least partially open), while the at least one pump 14 (with the separating valve 26 closed) is used only to bridge a functional impairment or failure of the motorized piston-cylinder device 12. The pressure in the at least one wheel brake cylinder 10 of the brake module can be easily maintained by holding the first electric motor 16 of the motorized piston-cylinder device 12. Correspondingly, pressure reduction in the at least one wheel brake cylinder 10 of the brake module can also be effected by means of the motorized piston-cylinder device 12 (with the separating valve 26 at least partially open).

It is expressly pointed out that, by means of corresponding switching of the at least one wheel inlet valve 32 and the at least one wheel outlet valve 36, pressure build-up functions, pressure maintenance functions, and pressure reduction functions can also be performed in the at least one wheel brake cylinder 10 of the brake module. Advantageously, the brake module of FIG. 1 equipped with two wheel brake cylinders 10 has one wheel inlet valve 32 and one wheel outlet valve 36 per wheel brake cylinder 10, as a result of which wheel-specific pressure build-up, pressure maintenance and pressure reduction functions can be performed for each of its two wheel brake cylinders 10.

Optionally, a pressure sensor 50 can also be connected to the common line section 28. It is additionally pointed out here that the hydraulic brake module architecture shown in FIG. 1 can “breathe” well. This means that, in a completely de-energized state, for example if the vehicle is parked, the brake fluid reservoir 22 is connected to the wheel brake cylinders 10 in such a way that no brake pressure remains in the system. For this purpose, it is only necessary for the motorized piston-cylinder device to be moved into its initial position and for the separating valve 26 to be open.

Alternatively to the design of the brake fluid reservoir 22 shown in FIG. 1 and to its connection to a node point of the lines 20a, 20b and 34, a three-chamber reservoir can also be used. If applicable, each chamber of the three-chamber reservoir would be connected to one of the lines 20a, 20b and 34, wherein the chambers of the three-chamber reservoir are connected to one another via an overflow. Thus, in the event of a leakage, a loss of brake fluid can additionally be limited.

Although not shown in FIG. 1, a plurality of such wheel-specific or axle-specific brake modules can be mounted as a decentralized brake system on a vehicle/motor vehicle. For example, four wheel specific brake modules can be used at all four wheels of the particular motor vehicle, one axle-individual brake module can be used at a first axle and two wheel-specific brake modules can be used at the two wheels of a second axle of the particular motor vehicle, or one axle-individual brake module can be used at each of both axles of the particular motor vehicle as a decentralized brake system. A decentralized brake system realized in this way does not require hydraulic lines between the front axle and the rear axle of its vehicle/motor vehicle, in contrast to a conventional central brake system. Thus, the long brake lines from the engine compartment to the rear axle of a vehicle/motor vehicle equipped with a central brake system are also omitted.

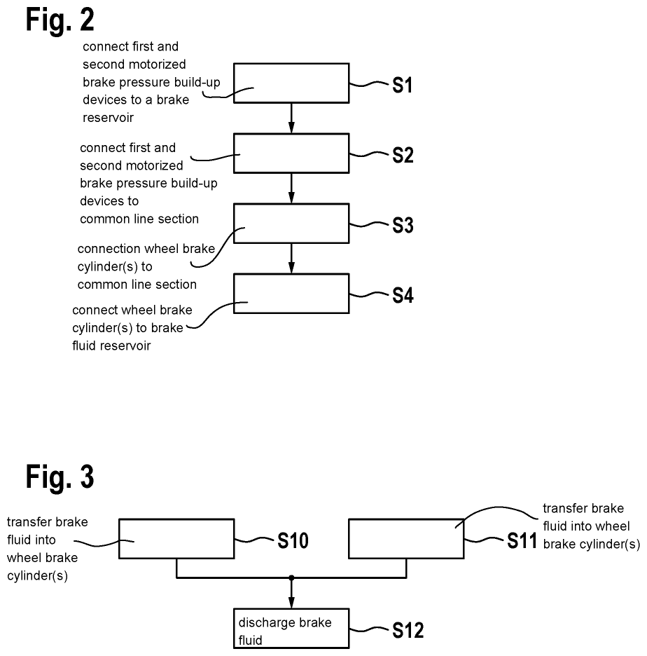

FIG. 2 is a flow diagram for explaining an embodiment of the manufacturing method for a wheel-specific or axle-specific brake module.

By means of the manufacturing method described below, for example, the wheel-specific or axle-specific brake module of FIG. 1 can be produced. However, the performance of the manufacturing method is not limited to producing the wheel-specific or axle-specific brake module of FIG. 1.

For manufacturing the wheel-specific or axle-specific brake module, a first motorized brake pressure build-up device, a second motorized brake pressure build-up device, at least one single-piston or multi-piston wheel brake cylinder, wherein a total number of wheel brake cylinders of the later brake module is less than or equal to 2, and at least one wheel inlet valve and/or wheel outlet valve are arranged at and/or in the brake module. In a method step S1, the first motorized brake pressure build-up device and the second motorized brake pressure build-up device are connected to a brake fluid reservoir of the brake module via a suction line in each case. In a method step S2, the first motorized brake pressure build-up device is connected to a common line section via a first supply line having a separating valve and the second motorized brake pressure build-up device is connected to the common line section via a second supply line. Furthermore, in a method step S3, the at least one wheel brake cylinder of the brake module is connected to the common line section via at least one further supply line having the at least one wheel inlet valve. Furthermore, in a method step S4, the at least one wheel brake cylinder of the brake module is connected to the brake fluid reservoir via at least one return line having the at least one wheel outlet valve. The method steps S1 to S4 can be performed simultaneously, with a temporal overlap, and in any order.

FIG. 3 is a flow diagram for explaining an embodiment of the method for operating a wheel-specific or axle-specific brake module.

By means of the method described here, for example, the wheel-specific or axle-specific brake module of FIG. 1 can be operated. However, the performance of the method is not limited to operating the wheel-specific or axle-specific brake module of FIG. 1.

In a method step S10, brake fluid is transferred into at least one single-piston or multi-piston wheel brake cylinder of the brake module by means of operation of a first motorized brake pressure build-up device. During this, the first motorized brake pressure build-up device is connected to a brake fluid reservoir of the brake module via a first suction line and to a common line section via a first supply line having a separating valve, while the at least one wheel brake cylinder of the brake module is connected to the common line section via at least one further supply line having at least one wheel inlet valve. Thus, the transfer of brake fluid occurs through the at least partially open separating valve, (after passing through the separating valve) through the common line section and (after passing through the common line section) through at least one at least partially open wheel inlet valve. A total number of wheel brake cylinders of the brake module is less than or equal to 2.

In a method step S11, brake fluid is transferred by means of operation of a second motorized brake pressure build-up device, which is connected to the brake fluid reservoir via a second suction line and to the common line section via a second supply line, through the common line section and through the at least one at least partially open wheel inlet valve into the at least one wheel brake cylinder of the brake module. The method steps S10 and S11 can be performed alternatively and/or simultaneously.

In a further method step S12, brake fluid is discharged from the at least one wheel brake cylinder of the brake module, which is connected to the brake fluid reservoir via at least one return line having at least one wheel outlet valve, through the at least one at least partially open wheel outlet valve into the brake fluid reservoir. Thus, the performance of the method steps S10 to S12 described here provides the advantages explained above.

1-11. (canceled)

12. A wheel-specific or axle-specific brake module, comprising:
a first motorized brake pressure build-up device;
a second motorized brake pressure build-up device;
at least one single-piston or multi-piston wheel brake cylinder, wherein a total number of wheel brake cylinders of the brake module is less than or equal to 2;
at least one wheel inlet valve; and
at least one wheel outlet valve;
wherein:
the first motorized brake pressure build-up device is connected to a brake fluid reservoir of the brake module via a first suction line, and the second motorized brake pressure build-up device is connected to the brake fluid reservoir via a second suction line;
the first motorized brake pressure build-up device is connected to a common line section via a first supply line having a separating valve, and the second motorized brake pressure build-up device is connected to the common line section via a second supply line;
the at least one wheel brake cylinder of the brake module is connected to the common line section via at least one further supply line having the at least one wheel inlet valve; and
the at least one wheel brake cylinder of the brake module is connected to the brake fluid reservoir via at least one return line having the at least one wheel outlet valve.

13. The wheel-specific or axle-specific brake module according to claim 12, wherein, by operating the first motorized brake pressure build-up device, brake fluid can be transferred through the separating valve in an at least partially open state, through the common line section, and through the wheel inlet valve in an at least partially open state into the at least one wheel brake cylinder of the brake module, by operating the second motorized brake pressure build-up device, brake fluid can be transferred through the common line section and through the wheel inlet valve in the at least partially open state into the at least one wheel brake cylinder of the brake module, and brake fluid can be discharged from the at least one wheel brake cylinder of the brake module through the wheel outlet valve in an at least partially open state into the brake fluid reservoir.

14. The wheel-specific or axle-specific brake module according to claim 12, wherein a first end of the second supply line opens into the second motorized brake pressure build-up device and a second end of the second supply line opens into the common line section, and the second supply line is a valve-free line path.

15. The wheel-specific or axle-specific brake module according to claim 12, wherein a line having a check valve runs parallel to the separating valve.

16. The wheel-specific or axle-specific brake module according to claim 12, wherein a check valve is arranged in the first suction line and/or a check valve is arranged in the second suction line.

17. The wheel-specific or axle-specific brake module according to claim 16, wherein the check valve is arranged in the first suction line, and wherein the check valve in the first suction line is a spring-loaded check valve.

18. The wheel-specific or axle-specific brake module according to claim 12, wherein the first motorized brake pressure build-up device is a motorized piston-cylinder device having at least one linearly movable piston, and the second motorized brake pressure build-up device is at least one pump.

19. The wheel-specific or axle-specific brake module according to claim 12, wherein the separating valve is a normally open valve.

20. The wheel-specific or axle-specific brake module according to claim 12, wherein the brake module includes at least one control unit, wherein, using the at least one control unit, the first motorized brake pressure build-up device and the second motorized brake pressure build-up device are controllable in such a way that brake fluid can be transferred into the at least one wheel brake cylinder of the brake module by operation of the first motorized brake pressure build-up device and simultaneously by operation of the second motorized brake pressure build-up device.

21. A manufacturing method for a wheel-specific or axle-specific brake module, the method comprising the following:
arranging a first motorized brake pressure build-up device, a second motorized brake pressure build-up device, at least one single-piston or multi-piston wheel brake cylinder, at least one wheel inlet valve, and at least one wheel outlet valve at and/or in the brake module, wherein a total number of wheel brake cylinders of the brake module is less than or equal to 2;
wherein:
each of the first motorized brake pressure build-up device and the second motorized brake pressure build-up device are connected to a brake fluid reservoir of the brake module via a respective suction line;
the first motorized brake pressure build-up device is connected to a common line section via a first supply line having a separating valve, and the second motorized brake pressure build-up device is connected to the common line section via a second supply line;
the at least one wheel brake cylinder of the brake module is connected to the common line section via at least one further supply line having the at least one wheel inlet valve; and
the at least one wheel brake cylinder of the brake module is connected to the brake fluid reservoir via at least one return line having the at least one wheel outlet valve.

22. A method for operating a wheel-specific or axle-specific brake module, comprising the following steps:
transferring brake fluid by operating a first motorized brake pressure build-up device, which is connected to a brake fluid reservoir of the brake module via a first suction line and to a common line section via a first supply line having a separating valve, through the separating valve in an at least partially open state, through the common line section, and through at least one at least partially open wheel inlet valve into at least one single-piston or multi-piston wheel brake cylinder of the brake module, which is connected to the common line section via at least one further supply line having the at least one wheel inlet valve, wherein a total number of wheel brake cylinders of the brake module is less than or equal to 2;
transferring brake fluid by operating a second motorized brake pressure build-up device, which is connected to the brake fluid reservoir via a second suction line and to the common line section via a second supply line, through the common line section and through the at least one at least partially open wheel inlet valve into the at least one wheel brake cylinder of the brake module; and
discharging brake fluid from the at least one wheel brake cylinder of the brake module, which is connected to the brake fluid reservoir via at least one return line having at least one wheel outlet valve, through the wheel outlet valve in an at least partially open state into the brake fluid reservoir.
